(19) United States
(12) Patent Application Publication
(10) Pub. No.: US 2007/0181669 A1
(43) Pub. Date: Aug. 9, 2007

(54) Personalized calling card including indicia for conveying information about the cardholder's offspring

(75) Inventor: Renae K. Ryan, Grand Rapids, MI (US)

Correspondence Address: MILLER JOHNSON SNELL CUMMISKEY, PLC, 800 CALDER PLAZA BUILDING, 250 MONROE AVE N W, GRAND RAPIDS, MI, 49503-2250, US

(73) Assignee: MomCard, LLC

(21) Appl. No.: 11/348,568

(22) Filed: Feb. 7, 2006

(51) Int. Cl. G06K 5/00

(52) U.S. Cl. 235/380

(57) ABSTRACT

A personalized calling card (100) includes personal information (103-111) and also includes indicia signifying the cardholder's children (113) that conveys information regarding their number, gender and and/or birth order (115).

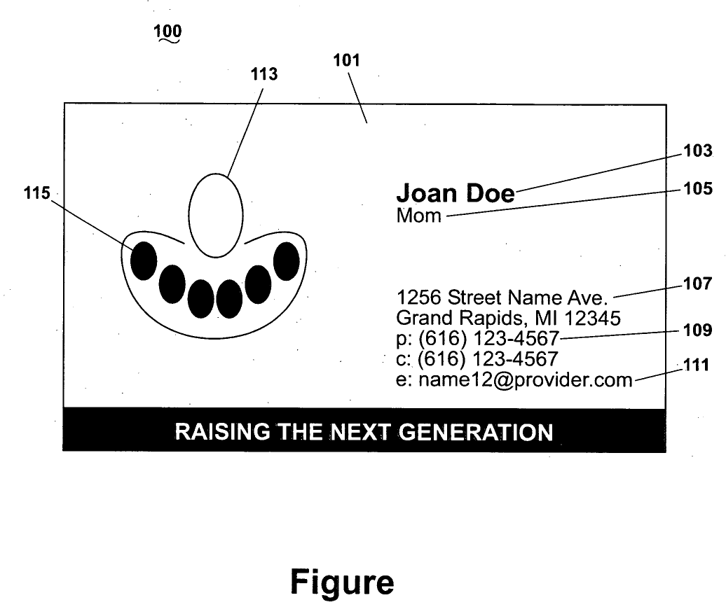

### FIELD OF THE INVENTION

The present invention relates generally to a personalized calling card and more particularly to a calling card with indicia for indicating number of offspring and their birth order.

### BACKGROUND

Business cards have been used by businessmen and women for literally hundreds of years to secure and promote business ventures. Generally, business cards are small pocket-sized cards that include company information such as company logo, name, title, address, telephone and/or other contact information. Those skilled in the art will recognize that “business” card refers not only to cards used for business but also cards used to convey personal information.

One specialty personalized calling card that has been utilized is a card used by parents, namely, “mothers” to convey information about them. Many mothers use personalized calling cards in a manner allowing them to exchange personal information through this “mom” personalized calling card. This permits mothers. to easily network by exchanging cards without the need to quickly and/or inaccurately write down personal contact information during a chance meeting or other engagement.

One problem in using typical personalized calling cards by mothers is the information printed on the card. Most often, cards only include contact information and do not include information about family members including children, pets or the like. Therefore, the need exists to provide a personalized calling card that includes information not typically found on a card in order to keep moms or other individuals from having to manually write the information onto portions of the card.

### BRIEF DESCRIPTION OF THE FIGURES

The accompanying figures, wherein like reference numerals refer to identical or functionally similar elements throughout the separate views and which together with the detailed description below are incorporated in and form part of the specification, serve to further illustrate various embodiments and to explain various principles and advantages all in accordance with the present invention.

The FIGURE illustrates a typical personalized calling card having indicia signifying the number and birth order of the cardholder's children in accordance with embodiments of the invention.

Skilled artisans will appreciate that elements in the figure are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to a personalized calling card that includes indicia representing the cardholder's children. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

Turning now to the FIGURE, the personal personalized calling card 100 includes information printed on paper card stock 101 or the like. The information may include but is not limited to the cardholder's name 103, title 105, such as “mom,” home address 107, telephone information 109 and email information 111.

The invention is unique in that the card includes indicia 113 which signify the number and/or birth order of the cardholder's offspring. Those skilled in the art will recognize the term “offspring” refers to the cardholder's progeny including children, grandchildren and/or great grandchildren, etc. In the example represented by the FIGURE, the indicia include a design symbolizing a mother's outstretched arms and oval shapes 115 to denote the number of offspring of the cardholder. Color or other means may be used with an artistic symbol or an indicator of affiliation where each oval is used to represent the gender of the offspring. This information can also be used, in turn, to designate the birth order of each child. Although this example illustrates six children, it should be evident to those skilled in the art that other indicators on the card stock 101 might be used to convey this information.

Thus, the invention is a personalized calling card that includes printed name indicia; printed address indicia; and indicia representing the number of offspring of the cardholder. The indicia may include the number of children as well as their gender and birth order. This information may be included within a decorative symbol or other affiliative means using color for easily conveying this personal information to card recipients.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

1. A method for utilizing a personalized calling card comprising the steps of:
establishing relationships between a first mother of children and at least one second mother of children; and
distributing at least one personalized calling cad having the birth order and gender of the first mother's children for acting as a memory aid for the at least one second mother.

2. A method for utilizing a personalized calling card as in claim 1, wherein the gender of the children is designated using at least one symbol using color.

3. A method for utilizing a personalized calling card as in claim 2, wherein the at least one symbol is an oval designating one child.

4. A method for establishing relationships between mothers of children comprising the steps of:
meeting at least one mother desiring to establish a sustained relationship; and
distributing a personalized calling card indicating the birth order and gender of the distributor's children in order to facilitate the introduction for use in establishing future contact between mothers.

5. A method for establishing a relationship between mothers as in claim 4, wherein the birth order and gender are positioned within decorative indicia in order to aid mothers receiving the card in rapidly identifying a distributor of the card.

6. A method for establishing a relationship between mothers as in claim 5, wherein the birth order and gender are conveyed using at least one colored oval within the decorative symbol.

7. A networking method for use by mothers of children in establishing personal relationships between mothers comprising the steps of:
networking with mothers of children; and
dispensing a personal calling card that identifies the birth order and gender of the distributor's children using at least one colored oval symbol.

8. A networking method for use by mothers of children as in claim 7, further comprising the step of:
positioning the at least one oval symbol within decorative indicia so the mother dispensing the card can be rapidly identified.
